(19) United States
(12) Patent Application Publication
(10) Pub. No.: US 2019/0227734 A1
(43) Pub. Date: Jul. 25, 2019

(54) TRACKING INFORMATION RELATED TO FREE SPACE OF CONTAINERS

(71) Applicant: HEWLETT PACKARD ENTERPRISE DEVELOPMENT LP, Houston, TX (US)

(72) Inventors: Shankar Iyer, Cupertino, CA (US); Ze Mao, Santa Clara, CA (US); Srinivasa D. Murthy, Cupertino, CA (US); William Michael McCormack, Fremont, CA (US)

(21) Appl. No.: 15/878,737

(22) Filed: Jan. 24, 2018

(51) Int. Cl. G06F 3/06

(52) U.S. Cl. CPC G06F 3/0653; G06F 3/0608; G06F 3/067; G06F 3/0659; G06F 3/0631

(57) ABSTRACT

In some examples, a system includes a memory to store tracking information relating to data containers and free space of each of the data containers. A processor is to determine a free space of a first data container of the data containers, the first data container storing compressed data, and update the tracking information based on the determined free space of the first data container.

### BACKGROUND

A storage system can include a storage device or an array of storage devices, including any or some combination of the following: a memory device (a volatile or non-volatile memory device), a disk-based persistent storage device, or any other type of device capable of storing data.

### BRIEF DESCRIPTION OF THE DRAWINGS

Some implementations of the present disclosure are described with respect to the following figures.

FIG. 1 is a block diagram of an arrangement including a storage controller and a storage system according to some examples.

FIG. 2 is a flow diagram of a process according to some examples.

FIG. 3 illustrates a container tracking information according to some examples.

FIG. 4 is a flow diagram of a read process according to further examples.

FIG. 5 is a flow diagram of a write process according to further examples.

FIG. 6 is a block diagram of a system according to further examples.

FIG. 7 is a block diagram of a storage medium storing machine-readable instructions according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some cases, a storage system can store data pages (or more simply “pages”) in compressed form into data containers (or more simply “containers”). A “data page” (or equivalently a “page”) can refer to a unit of data having a specified static size or a variable size. A “data container” (or equivalently a “container”) can refer to a logical (virtual) repository of data into which a data page or multiple data pages can be stored, where at least some of the data page(s) stored into the data container can be in compressed form. Compressing a data page can refer to encoding data in the data page using fewer bits than the original (uncompressed) version of the data page, so that the compressed version of the data page consumes less storage space than the uncompressed version of the data page.

Pages can be added to a container so long as the container has sufficient space to receive the pages. Once a given page is stored in a given container, the page can be subject to an overwrite with new data. As a result of overwriting the page with new data, the overwritten page may no longer fit in the given container. In some cases, a compressed version of the overwritten page may not fit in the given data page. In other cases, the overwritten page may no longer be compressible, such as due to the new data being of a form that is not capable of compression, or the new data associated with a policy or rule specifying that the new data is not to be compressed.

In some examples, if the overwritten page is unable to fit into its original container, then the storage system can allocate a new container, and the overwritten page can be moved from the original container into the new container. However, in some examples, even though this move frees up additional space in the original container, the additional space of the original container may not be used for writing other pages, such that this additional space of the original container is wasted.

Over time, as pages in many containers are overwritten and moved to new containers due to the inability of the overwritten pages to fit within their original containers, the overall data compression performance of the storage system can suffer. More specifically, as free space in respective containers become unused and wasted as a result of movement of pages from original containers to other containers, the overall compression ratio of the storage system suffers. A compression ratio refers to a ratio of the sum of the compressed size of data and the size of the free space of containers to the uncompressed size of data.

In accordance with some implementations of the present disclosure, the compression performance of a storage system can be improved by using tracking information relating to containers and free space of each of the containers. The tracking information allows free space of containers to be reused for storing pages.

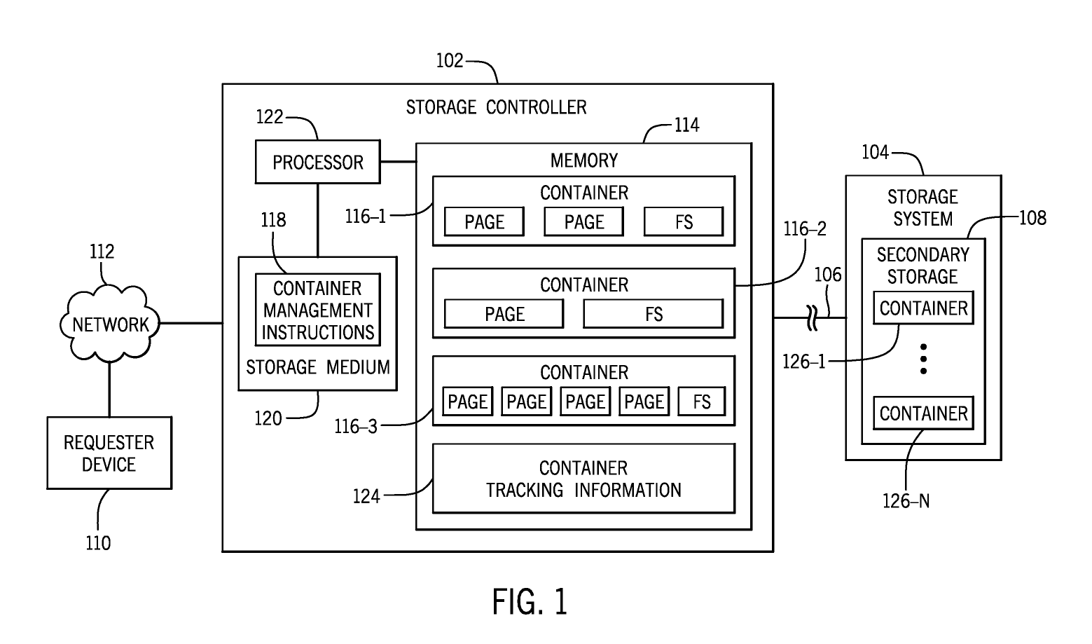

FIG. 1 is a block diagram of an example arrangement that includes a storage controller 102 that is coupled to a storage system 104 over a link 106. The storage controller 102 can be implemented with a computer or a collection of computers.

The storage system 104 includes a secondary storage 108, which can be implemented using a storage device or an array of storage devices. The storage device(s) of the secondary storage 108 can include a disk-based storage device, a solid state storage device, and so forth. The link 106 can include a wired link or a wireless link.

The storage controller 102 is able to receive a request from a requester device 110 over a network 112. In some examples, the network 112 can include a storage area network (SAN). In other examples, the network 112 can be a different type of network, such as a local area network (LAN), a wide area network (WAN), a public network (e.g., the Internet), and so forth.

The requester device 110 is able to submit a request (write request, read request, etc.) to access data managed by the storage controller 102, including data in the secondary storage 108 of the storage system 104 as well as data stored in a memory 114 of the storage controller 102. The memory 114 can be implemented with a memory device or with multiple memory devices. Examples of memory devices include a dynamic random access memory (DRAM) device, a static random access memory (SRAM) device, a flash memory device, and so forth. The memory 114 can be implemented with a volatile memory device and/or with a nonvolatile memory device.

Although just one requester device 110 is shown in FIG. 1, it is noted that in other examples, there can be multiple requester devices 110 that can submit requests to the storage controller 102. Examples of requester devices can include any or some combination of the following: a notebook computer, a tablet computer, a desktop computer, a server computer, a game appliance, a smartphone, and so forth.

In response to requests from the requester device 110, the storage controller 102 can perform corresponding storage access operations. The storage access operations retrieve the requested data either from the memory 114 (if the data is present in the memory 114) or retrieve the requested data from the secondary storage 118 of the storage system 104.

The requested data can be included in a page or in multiple pages. As shown in FIG. 1, the memory 114 can store pages in corresponding containers 116-1, 116-2, and 116-3. Although FIG. 1 shows three containers stored in the memory 114, it is noted that in other examples, there can be a different number of containers stored in the memory 114. If a page can be compressed, then the page is first compressed and stored in compressed form in a container. In some cases, a page may not be compressible, such as due to the data of the page being of a form that is not capable of compression, or the data of the page being associated with a policy or rule specifying that the data is not to be compressed. If a page is not compressible, then the page is stored in uncompressed form in a container.

Each container can store a number of pages (e.g., zero pages, one page, or more than one page). Depending on the number of pages stored in a container, a corresponding amount of free space (labeled “FS”) is available in the container. This free space is available for storing an additional page (or additional pages) that fit within the free space.

In addition to containers 116-1 to 116-3 stored in the memory 114 of the storage controller 102, containers 126-1 to 126-N (N>1) can also be stored in the secondary storage 108 of the storage system 104. In response to a request to access data, if the accessed data is in a container already in the memory 114, then the storage controller 102 can perform the requested operation (e.g., read or write) on the data in the container in the memory 114. However, if the accessed data is not in a container in the memory 114, then the storage controller 102 can first retrieve a container (one of 126-1 to 126-N) from the secondary storage 108 and store the retrieved container in the memory 114. After retrieving the container from the secondary storage 108 into the memory 114, the requested operation can be performed on the data in the retrieved container.

It is noted that the secondary storage 108 has a larger storage capacity than the memory 114, and can thus store a larger amount of data. Data is stored in the memory 114 to allow for quicker access to the data in the memory 114, since the memory 114 can have a faster access speed than the secondary storage 108.

The storage controller 102 also includes container management instructions 118, which can be stored in a storage medium 120. The storage medium 120 can be the same as the memory 114, or can be separate from the memory 120. The container management instructions 118 are computer-readable instructions executable on a processor 122 of the storage controller 102. A processor can include any or some combination of the following: a microprocessor, a core of a multicore microprocessor, a microcontroller, a programmable integrated circuit device, a programmable gate array, and so forth. Instructions executable on a processor can refer to instructions executable on a single processor or instructions executable on multiple processors.

The container management instructions 118 can manage the tracking of the free space available in the containers stored in the memory 114, and also manage the storing of pages into the containers in the memory 114.

The container management instructions 118 can use container tracking information 124 to track the amount of free space in each of the containers 116-1 to 116-3 stored in the memory 114. The tracking information 124 can be stored in the same memory 114 as the containers 116-1 to 116-3, or can be stored in a different memory than the memory 114. The container tracking information 124 includes information relating to the containers 116-1 to 116-3, and the free space of each of the containers 116-1 to 116-3. The container management instructions 118 can also update the container tracking information 124 based on the determined free space of each respective container. Note that the free space of a container can change as the container is changed, such as by adding a new page, removing a page, or overwriting a page.

It is noted that, in some examples, the container tracking information 124 tracks the free space of containers in the memory 114, but does not track the free space of containers 126-1 and 126-N that are stored in the secondary storage 108 but not in the memory 114.

As noted above, a container 126-1 or 126-N in the secondary storage 108 can be moved to the memory 114 in response to a request received by the storage controller 102. For example, if a request from the requester device 110 seeks a page that is located in the container 126-1 stored in the secondary storage 108, then the container 126-1 can be retrieved from the secondary storage 108 and stored into the memory 114. At that time, the container tracking information 124 can be updated to also refer to the container 126-1 that has been moved into the memory 114.

When a page is to be written into a container, the container management instructions 118 can access the container tracking information 124 to determine which of the containers 116-1 to 116-3 has sufficient space to store the page, and the container management instructions 118 can select one of the containers 116-1 to 116-3 based on the determination and write the page into the selected container.

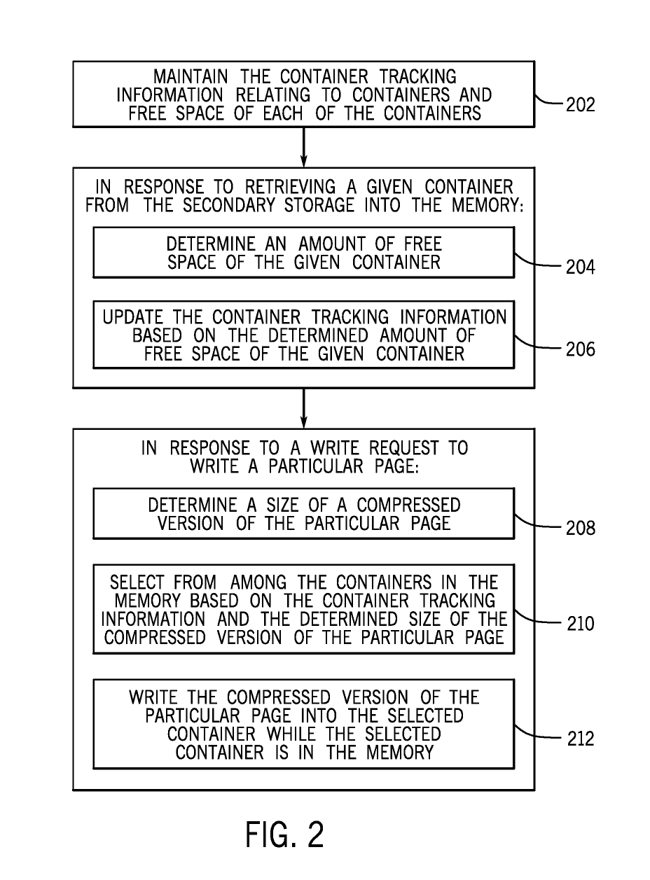

FIG. 2 is a flow diagram of a process that can be performed by the container management instructions 118 according to some examples. The container management instructions 118 maintain (at 202) the container tracking information 124 relating to containers 116-1 to 116-3 and free space of each of the containers in the memory 114.

In response to retrieving a given container from the secondary storage 108 into the memory 114, the container management instructions 118 determine (at 204) an amount of free space of the given container, and update (at 206) the container tracking information 124 based on the determined amount of free space of the given container.

In response to a write request to write a particular page, the container management instructions 118 determine (at 208) a size of a compressed version of the particular page. The container management instructions 118 further select (at 210) from among the containers in the memory 114 based on the container tracking information 124 and the determined size of the compressed version of the particular page. The container management instructions 118 write (at 212) the compressed version of the particular page into the selected container while the selected container is in the memory 114.

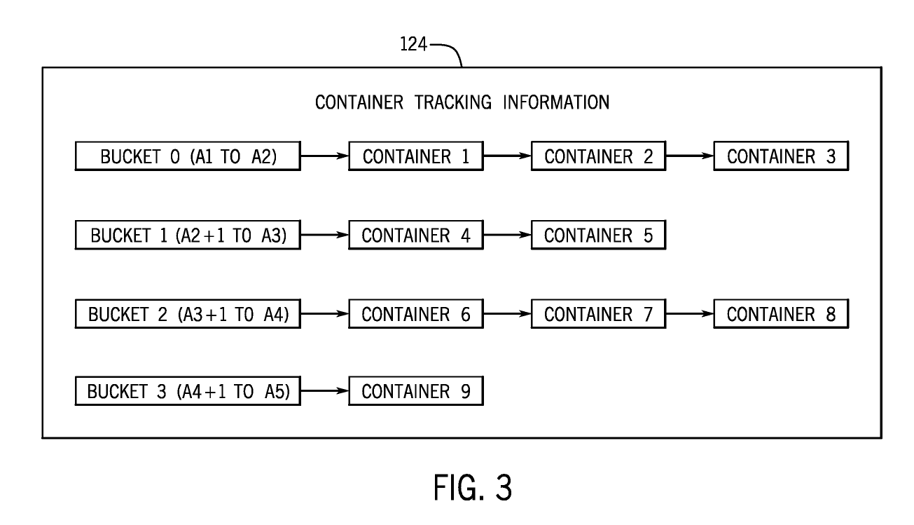

FIG. 3 shows an example of the container tracking information 124. In examples according to FIG. 3, the container tracking information 124 includes multiple buckets, which can be in the form of a list of buckets. Each bucket represents a corresponding different amount of free space available in a container.

In other examples, other forms of the container tracking information 124 can be used.

In FIG. 3, bucket 0 represents an amount of free space in a range from A1 to A2, where A1 can represent a predefined minimum amount of free space, such as 2 kilobytes (kB), and A2 can represent a different amount of free space, such as 4 kB.

Bucket 1 represents a different range of free space, from A2+1 to A3, where A2+1 represents an amount of free space that is 1 kB greater than A2, and A3 can represent a different amount of free space, such as 8 kB. Bucket 2 represents a free space range from A3+1 to A4, and bucket 3 represents a free space range from A4+1 to A5.

Although four buckets are depicted in FIG. 3, it is noted that the container tracking information 124 can include a different number of buckets in other examples.

Bucket 0 refers to containers (which in the example of FIG. 3 include containers 1, 2, 3) that each has free space in the range between A1 and A2. The reference from bucket 0 to each of containers 1, 2, and 3 can be in the form of a pointer or any other type of reference.

Bucket 1 refers to containers 4 and 5 that each has free space in the range between A2+1 an A3, bucket 2 refers to containers 6, 7, and 8 that each has free space in the range between A3+1 and A4, and bucket 3 refers to container 9 that has free space in the range between A4+1 and A5.

The container tracking information 124 that includes the multiple buckets associated with respective different ranges of container free space allows for “fast fit” of the container tracking information 124 with the respective containers. In other words, with the range-based container tracking information 124, containers having different available free space amounts can be quickly associated (fitted) with the respective buckets of the container tracking information 124. In this way, reduced processing resources are consumed in maintaining the container tracking information 124.

In other examples, other types of container tracking information 124 can be used, including one where a sorted list of containers having respective different free space amounts can be used. The containers can be sorted in ascending or descending order in this type of container tracking information 124.

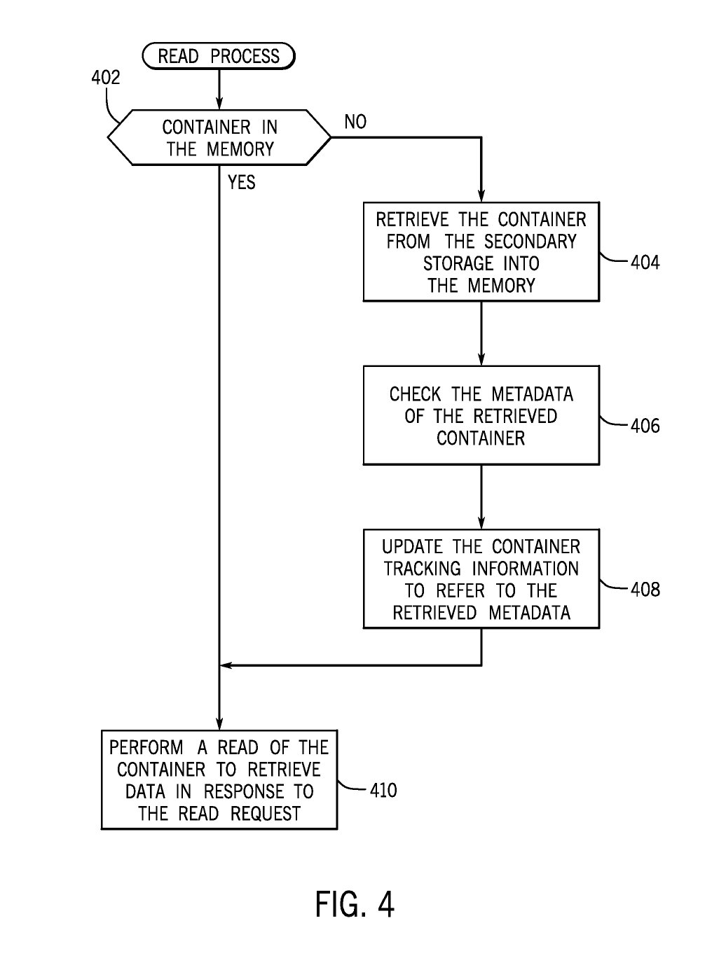

FIG. 4 is a flow diagram of a read process that is performed in response to a read request. The read process can be performed by the storage controller 102 (including the container management instructions 118) of FIG. 1, for example. In response to the read request, the storage controller 102 determines (at 402) whether the corresponding container that contains the requested page is in the memory 114. If not, the storage controller 102 retrieves (at 404) the corresponding container from the secondary storage 108 into the memory 114.

Each container can be associated with metadata, which can be part of a header of the container or can be otherwise associated with the container. The metadata can specify the amount of free space of the container, as well as identify a page (or multiple pages) included in the container. The storage controller 102 checks (at 406) the metadata of the retrieved container, and updates (at 408) the container tracking information 124 to refer to the retrieved container. The updating of the tracking information 124 can include adding information to the container tracking information 124 to indicate the amount of free space of the retrieved container determined based on the metadata. In examples where the container tracking information 124 includes buckets as shown in FIG. 3, the updating of the container tracking information 124 can include updating a corresponding bucket to refer to the retrieved container based on the amount of free space available in the retrieved container.

The storage controller 102 then performs a read (at 410) of the corresponding container in the memory 114 to retrieve data (a page or multiple pages) in response to the read request.

Although FIG. 4 shows an example where it is assumed that the data requested by the read request is in one container, it is noted that in other examples, the requested data can be from multiple containers.

The data read from the container(s) can be returned to the requester device 110 (FIG. 1) that submitted the read request.

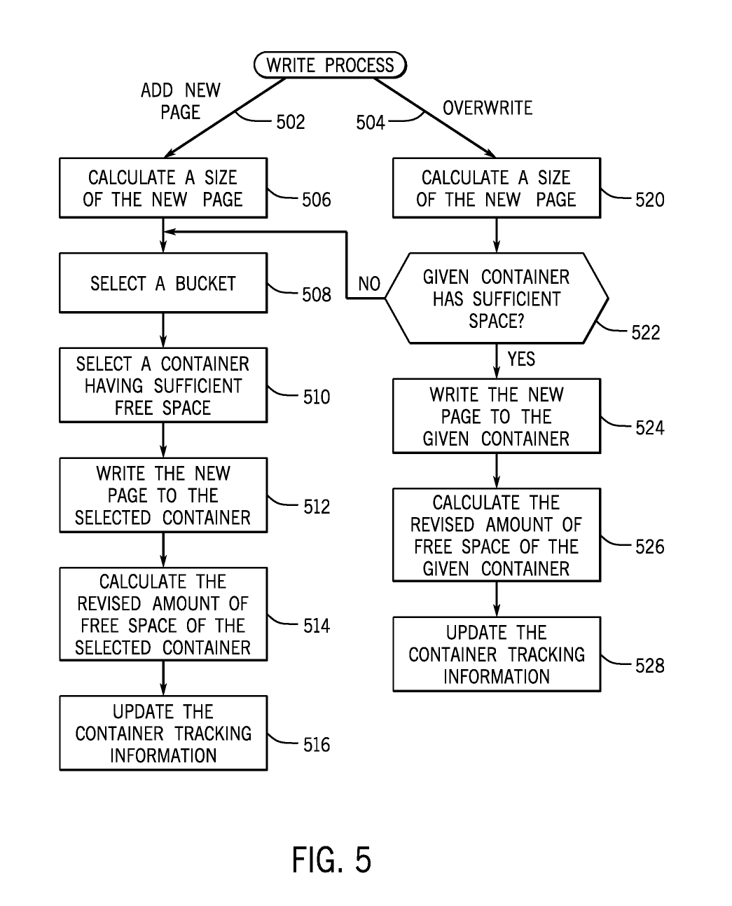

FIG. 5 is a flow diagram of a write process performed by the storage controller 102 (e.g., in whole or in part by the container management instructions 118) in response to a write request. The write process can perform different tasks based on whether the write request is to add a new page (502) or to overwrite an existing page in a container with a new page (504).

For adding a new page (502), the storage controller 102 calculates (at 506) the size of the new page that is to be written into a container. The calculated size of the new page can be the size of the compressed new page, assuming the new page can be compressed. To calculate the size of the compressed new page, the storage controller 102 can first apply compression on the new page, and use the size of the compressed new page as the calculated size. In other examples, the new page is uncompressible, in which case the size of the new page is the size of the uncompressed new page.

Based on the calculated size of the new page, the storage controller 102 accesses the container tracking information 124 to select (at 508) a bucket of the multiple buckets included in the container tracking information 124. The selection of the bucket can be based on a bucket selection criterion. For example, the bucket selection criterion can specify that the bucket selected is the one with a free space range that is just enough to accommodate the new page based on the calculated size. For example, if the calculated size of the new page is S1, and S1 is greater than the range A1 to A2 of bucket 0, but is within the free space range A2+1 to A3 of bucket 1, and less than the free space ranges for buckets 2 and 3, then this means that containers from any of buckets 1, 2, and 3 would be able to accommodate the new page. However, for most space savings, bucket 1 is selected since containers in bucket 1 would have just enough space to accommodate the new page. It may not be efficient to use containers from buckets 2 and 3 for the new page since those containers may have to be used for receiving larger new pages in subsequent operations.

More generally, to select (at 508) the bucket from multiple buckets, the storage controller 102 compares the calculated size of the new page to the free space ranges of the respective buckets, and selects the bucket associated with the smallest amount of free space that can still accommodate the new page.

The storage controller 102 selects (at 510), from the selected bucket, a container having sufficient free space in the memory 114. In examples where there are multiple containers that have sufficient free space, then the storage controller 102 can select one of the multiple containers based on a specified container selection criterion (e.g., the container with the smallest free space, the container with the largest free space, the container least recently used or most recently used, etc.).

The storage controller 102 writes (at 512) the new page (in compressed form if possible, otherwise in uncompressed form) to the selected container in the memory 114.

When the write of the new page to the selected container is completed, the storage controller 102 calculates (at 514) the revised amount of free space of the selected container. Based on the calculated revised amount of free space of the selected container, the storage controller 102 updates (at 516) the container tracking information 124.

In some examples, if the amount of free space of the selected container has changed such that the selected container should be associated with a different bucket in the list of buckets of the container tracking information 124 of FIG. 3, the updating of the container tracking information 124 may involve moving the corresponding container from one bucket to another bucket in the container tracking information 124. Moving a container from a first bucket to a second bucket can refer to changing the impacted buckets such that the first bucket no longer refers to the selected container and the second bucket refers to the selected container.

For overwriting an existing page with a new page (504), the storage controller 102 calculates (at 520) a size of the new page (similar to task 506). Note that the new page may overwrite an existing compressed page in a given container.

In some cases, the new page can have a size that is greater than the size of the existing compressed page in the given container. As a result, a compressed new page may not fit in the free space available in the given container. In some cases, the greater size of the new page can be due to the new page having more data than the existing page. In other cases, the new page may be less compressible than the existing compressed page, or the new page may not be compressible. In the latter cases, the increased size of the new page is due to the reduced compressibility of the new page.

The storage controller 102 determines (at 522), based on accessing the container tracking information 124, whether the given container containing the existing compressed page has sufficient space to receive the new page, based on the calculated size of the new page. The determination of whether the given container has sufficient space to receive the new page is based on the free space of the given container (as determined from the container tracking information 124), and a size of the existing compressed page that is to be overwritten. In other words, if the combined size of the existing compressed page to be overwritten and the free space of the given container is greater than or equal to the calculated size of the new page, then the new page can be written into the given container.

In response to determining (at 522) that the given container has a sufficient space to receive the new page, the storage controller 102 writes (at 524) the new page (in compressed form to the extent possible, otherwise in uncompressed form) into the given container. When the write of the new page to the given container is completed, the storage controller 102 calculates (at 526) the revised amount of free space of the given container. Based on the calculated revised amount of free space of the given container, the storage controller 102 updates (at 528) the container tracking information 124, similar to the updating at 516.

In response to determining (at 522) that the given container does not have a sufficient space to receive the new page, the storage controller 102 proceeds to task 508 to select a bucket and then to task 510 to select another container in the selected bucket to which to write the new page (instead of writing the new page to the given container that stores the existing compressed page). The container management instructions 118 can delete or mark as invalid the existing compressed page in the given container. The writing of the new page to the another container can use tasks 510 to 516 as discussed above.

Using techniques or mechanisms according to some implementations of the present disclosure, free space in containers can be reused. Moreover, as I/O operations are invoked and containers are retrieved from the secondary storage 108 into the memory 114, any free space available in such retrieved containers can also be used, such that as I/O operations progress, the amount of free space used in containers can be increased to enhance compactness of data stored in the containers. In other words, as I/O operations, compressed pages can be packed into the free space of the containers to improve the overall compression ratio of the system. Such a process gradually tunes and improves the compression ratio with reduced overhead (e.g., reduced processing burden) on the overall system. The larger the number of reads and writes (including overwrites), the better the compression ratio that can be achieved.

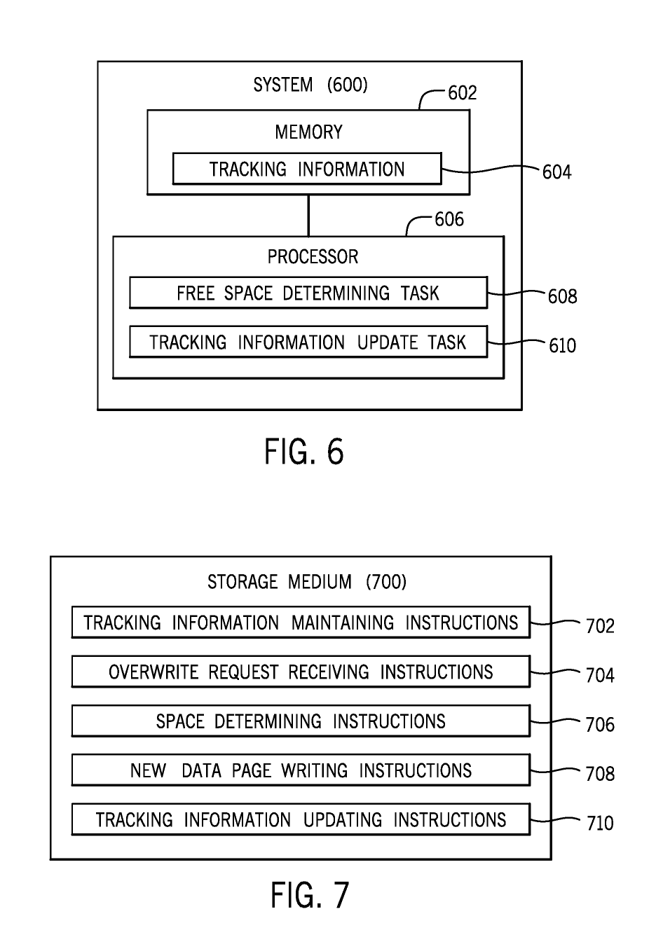

FIG. 6 is a block diagram of a system 600 that includes a memory 602 to store tracking information 604 relating to data containers and free space of each of the data containers. The system 600 further includes a processor 606 to execute instructions on a computer-readable storage medium to perform various tasks. A processor performing a task can refer to a single processor performing the task, or multiple processors performing the task. The tasks performed by the processor 606 include a free space determining task 608 to determine a free space of a first data container of the data containers, the first data container storing compressed data. The tasks further include a tracking information update task 610 to update the tracking information based on the determined free space of the first data container.

FIG. 7 is a block diagram of a non-transitory machine-readable or computer-readable storage medium 700 storing machine-readable instructions that upon execution cause a system to perform various tasks. The machine-readable instructions include tracking information maintaining instructions 702 to maintain tracking information relating to data containers and free space of each of the data containers, wherein a first of the data containers stores a compressed data page. The machine-readable instructions further include overwrite request receiving instructions 704 to receive a request to overwrite the compressed data page stored in the first data container with a new data page. The machine-readable instructions further include space determining instructions 706 to determine, based on accessing the tracking information, whether the first data container has sufficient space to receive the new data page.

The machine-readable instructions further include instructions that are invoked in response to determining that the first data container does not have sufficient space to receive the new data. Such instructions include new data page writing instructions 708 to write the new data page in a second data container of the data containers, and tracking information updating instructions 710 to update the tracking information to reflect a changed amount of the free space of the second data container as a result of the write.

The storage medium 700 can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A system comprising:
a memory to store tracking information relating to data containers and free space of each of the data containers, the tracking information comprising a plurality of buckets corresponding to different ranges of free space, the plurality of buckets comprising a first bucket corresponding to a first range of free space between a first free space amount and a second free space amount, and a second bucket corresponding to a second range of free space between a third free space amount and a fourth free space amount, the first bucket referring to a first subset of the data containers wherein each data container in the first subset has an amount of free space that falls in the first range, and the second bucket referring to a second subset of the data containers wherein each data container in the second subset has an amount of free space that falls in the second range; and
a processor to execute instructions on a computer-readable storage medium to:
determine a free space of a first data container of the data containers, the first data container storing compressed data, and
update the tracking information based on the determined free space of the first data container, the updating comprising adding a reference to a bucket of the plurality of buckets, the reference referring to the first data container.

2. The system of claim 1, wherein the processor is to execute instructions on the computer-readable storage medium to:
receive a request to overwrite the compressed data in the first data container with new data;
determine, based on accessing the tracking information, whether the first data container has sufficient space to receive the new data; and
write the new data to the first data container by overwriting the compressed data in the first data container, in response to determining that the first data container has sufficient space to receive the new data.

3. The system of claim 2, wherein the determining of whether the first data container has sufficient space to receive the new data is based on the free space of the first data container as indicated by the tracking information, and a size of the compressed data being overwritten by the new data.

4. The system of claim 2, wherein the determining of whether the first data container has sufficient space to receive the new data comprises determining whether the first data container has sufficient space to receive a compressed version of the new data.

5. The system of claim 2, wherein the determining of whether the first data container has sufficient space to receive the new data comprises:
determining that the new data is uncompressible; and
determining whether the first data container has sufficient space to receive the uncompressible new data.

6. The system of claim 1, wherein a given bucket of the plurality of buckets refers to multiple data containers each having an amount of free space that falls within a free space range of the given bucket.

7. The system of claim 6, wherein the processor is to execute instructions on the computer-readable storage medium to:
in response to a write changing an amount of free space of a given data container of the data containers, changing an association of the given data container from an association of the given data container with the first bucket to an association of the given data container with the second bucket.

8. The system of claim 1, wherein the processor is to execute instructions on the computer-readable storage medium to:
compress write data to produce compressed write data;
store the compressed write data in a given data container while the given data container is in the memory; and
update the tracking information to represent a changed amount of the free space of the given data container in response to the storing of the compressed write data in the given data container.

9. The system of claim 1, wherein the tracking information refers to the data containers in the memory, and does not refer to a data container in a secondary storage outside the memory.

10. The system of claim 1, wherein the processor is to execute instructions on the computer-readable storage medium to:
in response to an access of data in response to a request from a requester device:
retrieve a second data container from a secondary storage into the memory,
determine, based on metadata associated with the second data container, an amount of free space of the first second data container retrieved into the memory,
based on the determined amount of free space of the second data container retrieved into the memory, add a further reference to a bucket of the plurality of buckets, the further reference referring to the second data container, and
perform, in response to the request, an access operation of the second data container retrieved into the memory.

11. (canceled)

12. (canceled)

13. A non-transitory machine-readable storage medium storing instructions that upon execution cause a system to:
maintain tracking information relating to data containers and free space of each of the data containers, wherein a first of the data containers stores a compressed data page;
receive a request to overwrite the compressed data page stored in the first data container with a new data page;
determine, based on accessing the tracking information, whether the first data container has sufficient space to receive the new data page; and
in response to determining that the first data container does not have sufficient space to receive the new data page:
write the new data page in a second data container of the data containers, and
update the tracking information to reflect a changed amount of the free space of the second data container as a result of the write,
in response to determining that the first data container does have sufficient space to receive the new data page:
write the new data page to the first data container that overwrites the compressed data page, and
update the tracking information to reflect a changed amount of the free space of the first data container as a result of the write of the new data page to the first data container.

14. The non-transitory machine-readable storage medium of claim 13, wherein the determining of whether the first data container has sufficient space to receive the new data page to overwrite the compressed data page comprises determining whether the first data container has sufficient space to receive a compressed version of the new data page.

15. The non-transitory machine-readable storage medium of claim 13, wherein the determining of whether the first data container has sufficient space to receive the new data page comprises:
determining that the new data page is uncompressible; and
determining whether the first data container has sufficient space to receive the uncompressible new data page.

16. The non-transitory machine-readable storage medium of claim 13, wherein the instructions upon execution cause the system to further:
retrieve a given data container of the data containers into a memory from a secondary storage;
determine, based on metadata of the given data container, an amount of free space of the given data container; and
update the tracking information based on the determined amount of free space of the given data container.

17. The non-transitory machine-readable storage medium of claim 13, wherein the instructions upon execution cause the system to further:
in response to the request:
determine a size of the new data page,
select a bucket from among a plurality of buckets based on the determined size of the new data page according to a bucket selection criterion, the tracking information indicating ranges of free space associated with the plurality of buckets,
select the first data container from among the data containers referred to by the selected bucket based on the determined size of the new data page of the request.

18. A method executed by a system comprising a processor, comprising:
maintaining tracking information relating to data containers and free space of each of the data containers, the tracking information comprising a plurality of buckets corresponding to different ranges of free space, the plurality of buckets comprising a first bucket corresponding to a first range of free space between a first free space amount and a second free space amount, and a second bucket corresponding to a second range of free space between a third free space amount and a fourth free space amount, the first bucket referring to a first subset of the data containers wherein each data container in the first subset has an amount of free space that falls in the first range, and the second bucket referring to a second subset of the data containers wherein each data container in the second subset has an amount of free space that falls in the second range;
in response to retrieving a given data container from a secondary storage into a memory, determining an amount of free space of the given data container, and updating the tracking information based on the determined amount of free space of the given data container; and
in response to a write request to write a data page:
determine a size of a compressed version of the data page,
comparing the determined size to the different ranges of free space associated with the plurality of buckets;
select a first bucket of the plurality of buckets based on the comparing, and
write the compressed version of the data page into a first data container referred to by the first bucket while the first data container is in the memory.

19. The method of claim 18, further comprising:
updating the tracking information based on a changed amount of free space of the first data container responsive to the writing of the compressed version of the data page into the first data container, the updating of the tracking information based on the changed amount of free space of the first data container comprising removing a reference from the first bucket to the first container, and adding a reference to the first container to a second bucket of the plurality of buckets.

20. (canceled)

21. The system of claim 1, wherein the reference added to the bucket comprises a pointer to the first data container.

22. The system of claim 1, wherein the processor is to execute instructions on the computer-readable storage medium to:
receive a request to write new data,
calculate a size of the new page,
compare the calculated size to the different ranges of free space associated with the plurality of buckets,
select a bucket based on the comparing, and
write the new data to a data container referred to by the selected bucket.

23. The non-transitory machine-readable storage medium of claim 13, wherein the instructions upon execution cause the system to:
in response to determining that the first data container does not have sufficient space to receive the new data:
delete or mark as invalid the compressed data page in the first data container.
